(19) United States
(12) Patent Application Publication
(10) Pub. No.: US 2009/0202712 A1
(43) Pub. Date: Aug. 13, 2009

(54) POLARIZED LIGHT-EMITTING FILM AND METHOD FOR PRODUCING THE SAME

(75) Inventors: Hirokatsu Miyata, Hadano-Shi (JP); Sarah H. Tolbert, Los Angeles, CA (US); William C Molenkamp, Los Angeles, CA (US); Benjamin Joel Schwartz, Los Angeles, CA (US); Ignacio Bartolome Martini, Los Angeles, CA (US)

Correspondence Address: FITZPATRICK CELLA HARPER & SCINTO, 30 ROCKEFELLER PLAZA, NEW YORK, NY, 10112, US

(73) Assignees: CANON KABUSHIKI KAISHA, Tokyo (JP); THE REGENTS OF THE UNIVERSITY OF CALIFORNIA, Oakland, CA (US)

(21) Appl. No.: 12/403,084

(22) Filed: Mar. 12, 2009

Related U.S. Application Data
(62) Division of application No. 11/103,600, filed on Apr. 12, 2005, now abandoned.
Application No. 11/103,600 is a continuation-in-part of application No. 10/623,561, filed on Jul. 22, 2003, now abandoned.

(51) Int. Cl. B05D 5/06

(52) U.S. Cl. 427/163.1

(57) ABSTRACT

A polarized light-emitting layer that comprises a porous silica film formed on a substrate and a conjugated polymer held in the uniaxially oriented, tubular mesopores in the porous silica film. The film can emit fluorescence polarized in a direction parallel to the alignment direction of the mesopores. The film can act as a lasing layer with a low excitation threshold.

This is a continuation-in-part application of U.S. patent application Ser. No. 10/623,561 filed on Jul. 22, 2003.

This work was supported by grant number N00014-99-1-0568, awarded by the Office of Naval Research. The United States Government has certain rights in this invention. The continuation-in-part was partly supported by grant number N00014-04-1-0410, awarded by the US Office of Naval Research.

### BACKGROUND OF THE INVENTION

1. Field of the Invention

The present invention relates to a novel composite material utilizing a film of a porous material having ultra-minute pores (mesopores) formed in a self-organizing manner. More specifically, the present invention relates to a novel optical composite material, a polarized light-emitting film prepared utilizing a porous film material having a controlled mesopore structure, and a method for producing the same.

2. Related Background Art

Several attempts have been made to obtain polarized-light emission by controlling the orientation of polymer chains of a polymer. For example, a method where a polymer film is extended in one direction has been reported. One of the methods for controlling the orientation of polymer chains is utilization of nanospace of porous materials.

Generally, porous materials are classified into the following three classes by an IUPAC definition according to their pore sizes:

1. microporous materials (pore size<2 nm);
2. mesoporous materials (pore size 2 nm-50 nm); and
3. macroporous materials (pore size>50 nm).

The mesoporous materials have a feature that they are formed into various macroscopic morphologies other than powders under peculiar synthetic conditions. Monolith, films, fibers, spheres, and hollow spheres have been obtained, and the respective applications are expected.

For example, Science, Vol. 288, pp. 652 (2000) reports that the mesoporous structure of a mesostructured silica was controlled to control the orientation of a polymer material held in the mesostructured silica. According to this report, the mesostructured silica was prepared in a strong magnetic field to control the orientation of the mesopores, and a conjugated polymer was introduced into the mesopores, whereby polarized light-emission was observed.

However, a large sized apparatus is required to generate the above-mentioned strong magnetic field for controlling the orientation of the mesopores of the mesostructured silica. Furthermore, the mesopore structure in the resultant mesostructured silica has a relatively wide distribution in the mesopore orientation. Finally, the mesostructured material obtained by this procedure is monolithic, with macroporous voids between domains that produce an opaque, low optical quality material.

### SUMMARY OF THE INVENTION

The inventors of the present invention have succeeded to prepare a film having high polarization anisotropy by forming a mesostructured silica film having highly uniaxially oriented mesopores by a simple method, and introducing light-emitting conjugated polymer molecules into the mesopores to strictly control the orientation of the polymer chains.

Thus, according to one aspect of the present invention, there is provided a polarized light-emitting film comprising a porous silica film formed on a substrate and a conjugated polymer held in a plurality of uniaxially oriented, tubular mesopores in the porous silica film, wherein fluorescence emitted from the film is polarized in a direction parallel to the orientation direction of the mesopores.

According to the present invention, the film emits fluorescence of which the intensity measured through a polarizer with a polarization direction of the polarizer parallel to the orientation direction of the mesopores is ten times or more of the fluorescence intensity measured through a polarizer with a polarization direction perpendicular to the orientation direction of the mesopores.

According to the present invention, the film is preferably a mesostructured silica film formed using assemblies of surfactant molecules as a template.

According to the present invention, the porous silica film may be patterned in a desired shape.

According to the present invention, the substrate is capable of controlling the orientation of the tubular mesopores in the mesostructured silica formed thereon to one direction.

According to the present invention, it is preferable that the substrate has a polymer film on a surface thereof, the polymer film is capable of controlling the direction of the tubular mesopores in the mesostructured silica formed thereon to one direction. Preferably, the polymer film has a structural anisotropy in a plane.

According to the present invention, the conjugated polymer is preferably poly[2-methoxy-5-(2′-ethyl-hexyloxy)-1,4-phenylene vinylene].

According to another aspect of the present invention, there is provided a method for producing a polarized light-emitting film comprising the steps of:

forming on a substrate a mesostructured silica, film containing a plurality of tubular molecular assemblies of molecules of a surfactant aligned in one direction;

removing the surfactant from the mesostructured silica film to form hollow tubular mesopores;

reacting the surfaces of the hollow mesopores with a silane coupling agent; and

introducing a conjugated polymer into the mesopores.

According to the present invention, a step of patterning the mesostructured silica film in a desired pattern is preferably carried out after the step of forming on a substrate a mesostructured silica film containing a plurality of tubular molecular assemblies of molecules of a surfactant arranged in one direction; and before the step of removing the surfactant from the mesostructured silica film to form hollow tubular mesopores.

According to the film forming method of the present invention, the substrate is capable of controlling the orientation of the tubular mesopores in the mesostructured silica formed thereon to one direction.

According to still another aspect of the present invention, there is provided a method for producing a polarized light-emitting film comprising the steps of:

forming on a substrate a polymer film that is capable of controlling an orientation of the tubular mesopores in a mesostructured silica to one direction;

forming on the polymer film a mesostructured silica film containing a plurality of tubular molecular assemblies of molecules of a surfactant arranged in one direction;

removing the surfactant from the mesostructured silica film to form hollow tubular mesopores;

reacting the surfaces of the hollow mesopores with a silane coupling agent; and

introducing a conjugated polymer into the mesopores.

According to the present invention, a step of patterning the film of the mesostructured silica in a desired pattern is preferably carried out after the step of forming on a substrate a mesostructured silica film containing a plurality of tubular molecular assemblies of molecules of a surfactant arranged in one direction; and before the step of removing the surfactant from the mesostructured silica film to form hollow tube-shaped mesopores.

According to the film production method of the present invention, the surfactant is preferably removed by calcination.

### BRIEF DESCRIPTION OF THE DRAWINGS

FIG. 1 is a schematic view illustrating the structure of a polarized light-emitting film according to the present invention, where conjugated polymer molecules are held in the uniaxially orientated tubular mesopores of a mesoporous silica film formed on a substrate;

FIG. 2 is a schematic view illustrating a reaction vessel used for producing a mesostructured silica containing uniaxially oriented tubular surfactant micelles;

FIG. 3 is a schematic view illustrating a mesostructured silica film having uniaxially oriented tubular surfactant micelles, formed on a polymer film having surface anisotropy;

FIG. 4 is a schematic view illustrating a mesostructured silica film having oriented tubular surfactant micelles, formed on a crystalline substrate having surface anisotropy;

FIG. 5 shows the chemical formula of MEH-PPV used in the present invention;

FIG. 6 shows the fluorescent spectra of a polarized light-emitting film with different measurement arrangements, where the film is a mesoporous silica film produced in Example 1 containing MEH-PPV in the uniaxially oriented tubular mesopores in the film;

FIG. 7 is a schematic view illustrating the structure of a polarized light-emitting film patterned in a line shape, produced in Example 2 of the present invention;

FIG. 8 is a schematic view illustrating a rectangularly shaped composite film formed on a substrate with two paired sides, from only one paired sides of which lasing takes place;

FIG. 9 is a schematic view illustrating the structure of the lasing device fabricated in Example 4;

FIG. 10 is a schematic view illustrating the geometry for the measurement of lasing behavior used in Example 4;

FIG. 11 is a graph showing the excitation power dependence of the emission spectra observed in Example 4;

FIG. 12 is a graph showing the change of the emission width observed in Example 4;

FIG. 13 is a graph showing polarization of the lasing light observed in Example 4;

FIG. 14 is a graph showing the change of the emission width observed in blends of different concentrations of MEH-PPV in polystyrene, compared to the emission width of the present invention observed in Example 4; and

FIG. 15 is a schematic of the graded refractive index of the composite used in Example 4

### DESCRIPTION OF THE PREFERRED EMBODIMENTS

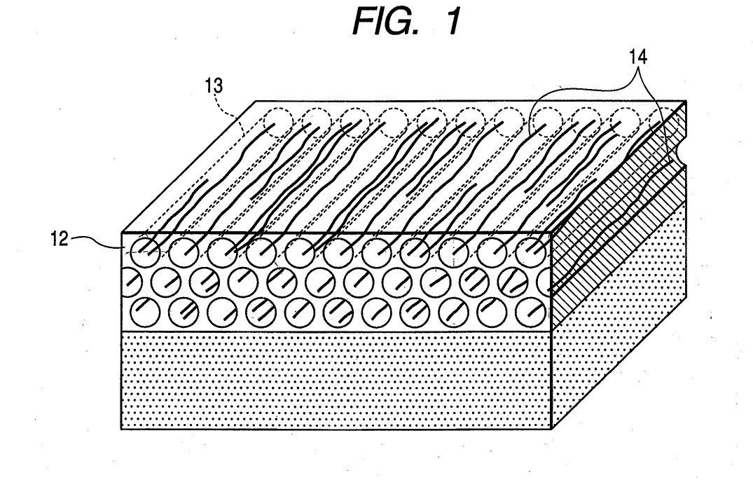

A polarized light-emitting film of the present invention has a structure schematically shown in FIG. 1.

A porous silica film 12, in which tubular mesopores 13 are uniaxially oriented, is formed on a substrate 11, and a conjugated polymer 14 is held in the mesopores.

First, a method for producing a porous silica film with tubular mesopores uniaxially orientated on a substrate will be described. The porous silica used in the present invention is formed using micelles (assemblies) of molecules of a surfactant as a template, and is called mesoporous silica. Various methods for producing a mesoporous silica film have been reported. These methods are roughly classified into a method called solvent evaporation method and a method based on heterogeneous nucleation and growth occurring at the solid-liquid interface. The mesoporous silica film used in the present invention may be produced by either method, as long as the orientation of the mesopores on a substrate is controlled in one direction. According to the method based on the heterogeneous nucleation and growth at the solid-liquid interface, the mesostructure formed on a substrate may reflect the surface anisotropy of the substrate. For example, control of the orientation of mesopores by using a crystalline substrate having surface anisotropy is reported in Journal of the American Chemical Society, Vol. 121, pp. 7618 (1999), and control of the orientation of mesopores using a polymer film formed on a substrate is reported in Chemistry of Materials, Vol. 11, pp. 1609 (1999).

In the present invention, a mesoporous silica film is preferably used, which is produced by a method based on heterogeneous nucleation and growth of mesostructured silica. This production method will be described below.

First, the substrate preparation process is described.

Here described is a method using a substrate provided with a polymer film having surface anisotropy. However, substrates applicable to the present invention are not limited thereto. For example, as described above, crystalline substrates having surface anisotropy, such as the (110) plane of silicon single crystal, can also be used. Needless to say, in this case, the process of forming a polymer film described below is not required.

A polymer film having surface anisotropy can be produced, for example, by a rubbing method or the Langmuir-Blodgett method. However, the method for forming a polymer film having surface anisotropy used in the present invention is not limited to these two methods. Any method is applicable as long as anisotropy can be induced. For example, anisotropy may be endowed by irradiating with polarized light.

The rubbing method is as follows: First, a polymer film is formed on the substrate surface by spin coating, dip coating, or the like, and then a rotary roller wrapped around with a cloth is pressed against the film to rub the film in one direction. There is no particular limitation to the polymer material to be used, as long as the material can withstand the mesostructured silica film production process described later. For example, polyimide, polyamide, polystyrene, or the like can be used. A polyimide film can be prepared by coating a substrate with the corresponding precursor polyamic acid followed by the imidization by heat treatment. The substrate on which the polymer film is formed can be of any material, as long as it can withstand the mesostructured silica film preparation process described later, including quartz, glass, silicon substrate, or the like. There is no particular limitation to the thickness of the polymer film. The thickness is preferably in the range of several nm to hundreds of nm. Also there is no particular limitation to the material of the cloth to be wrapped around the rubbing roller. For example, cotton, nylon, or the like can be used. Anisotropy resulting from the rubbing treatment varies depending upon the structure of the polymer used; it may be mainly shape anisotropy, or it may be anisotropy both in shape and the polymer structure. According to the present invention, either may be adopted as long as the orientation of mesopores formed on the polymer can be controlled in one direction.

Next, the Langmuir-Blodgett method is described. According to the Langmuir-Blodgett method, a single molecular film of an amphiphile formed at a gas-liquid interface is transferred onto a substrate, and, a desired film thickness can be obtained by lamination. The Langmuir-Blodgett film used herein includes not only a film which is formed on a gas-liquid interface and transferred to a substrate, but also a film modified after being transferred to the substrate. The Langmuir-Blodgett film can also be made from a polymer. For example, a polyimide Langmuir-Blodgett film can be prepared as follows: An alkylamine salt of polyamic acid, a precursor of polyimide, is synthesized and dissolved in an appropriate solvent, and the resultant solution is dropped onto a water surface. Then a substrate is immersed in and is withdrawn from water repeatedly to form a Langmuir-Blodgett film of a desired film thickness on the substrate. After the film formation, the film is heat-treated in a nitrogen atmosphere for the dehydration-imidization and deamination, whereby a polyimide Langmuir-Blodgett-film is produced. In the polyimide Langmuir-Blodgett film thus produced, polymer chains are oriented in the moving direction of the substrate during the film formation, which is confirmed by polarized infrared absorption spectroscopy or the like.

Then, a mesostructured silica film is formed on the substrate having an anisotropic polymer film prepared as described above.

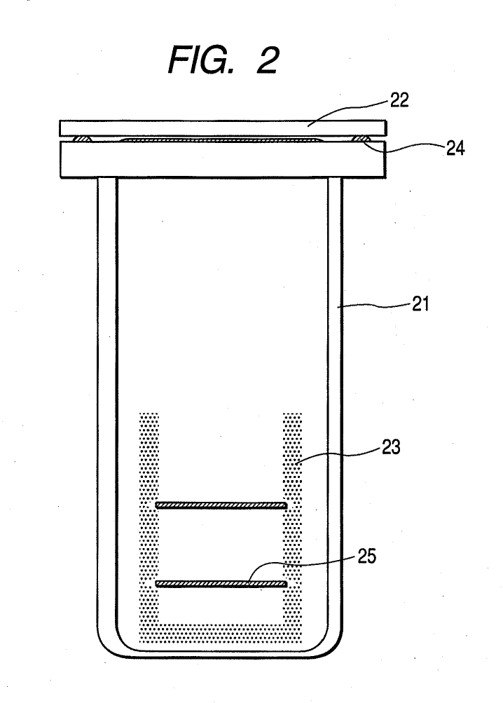

A mesostructured silica film can be formed by holding the above-mentioned substrate in an aqueous solution containing a surfactant, silicon alkoxide (a silica source), and an acid that works as a hydrolysis catalyst. The substrate is held in the solution with the surface having the polymer film downward in order to prevent the deposition of the precipitation on the surface. FIG. 2 schematically shows a reaction vessel 21 used for producing a film. There is no particular limitation to the material of the reactor 21, as long as it is inactive to the reactant solution. For example, Teflon can be used preferably. Holding a substrate 25 in the solution, the reactant vessel 21 is placed in an oven at about 60° C. to 120° C., and reaction is carried out for from several hours to several days. In order to prevent the damage of the reactor 21 and the leakage of liquid during heating, the reactor 21 is provided with a lid 22 and an O-ring 24 for sealing. The reactor 21 in FIG. 2 may be further placed in a tough container made of stainless steel or the like.

Various surfactants can be used as the surfactant, such as cationic surfactants (e.g., alkylammonium) and non-ionic surfactants having ethylene oxide as a hydrophilic group. For example, cetyl trimethyl ammonium chloride or polyoxyethylene cetyl ether can be used.

As the alkoxide that can be used as a silica source, tetraethoxysilane, tetramethoxysilane, tetrapropoxysilane, and the like are preferably used.

Examples of the acid that works as a hydrolysis catalyst are hydrochloric acid, nitric acid, and sulfuric acid. Hydrochloric acid is most generally used.

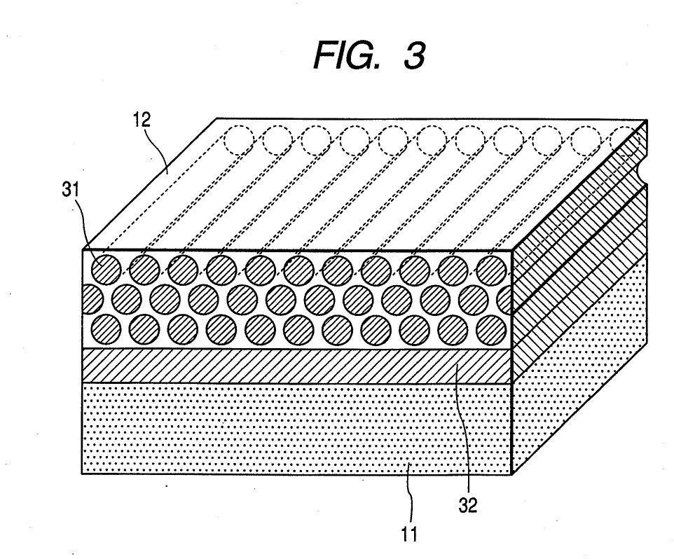

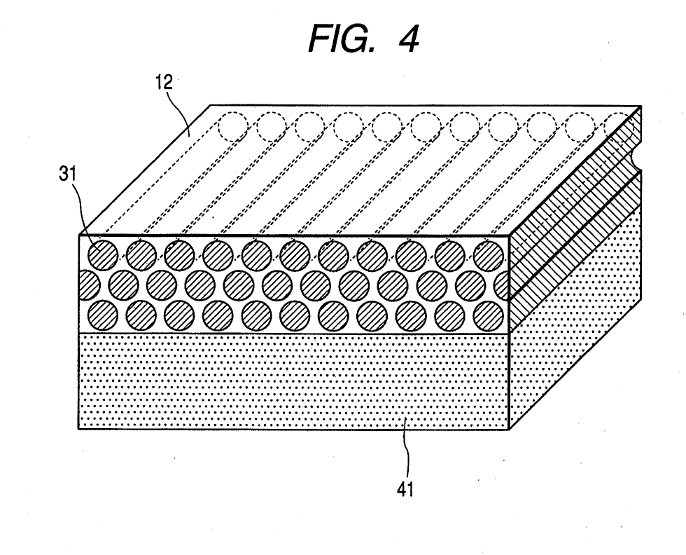

FIG. 3 schematically shows a mesostructured silica film formed on a substrate. In FIG. 3, reference numeral 11 denotes a substrate and 32 denotes a polymer film having surface anisotropy. A film of a mesostructured silica 12, in which tubular surfactant molecular assemblies 31 are oriented in one direction, is formed on the polymer film. FIG. 4 schematically shows a mesostructured silica film formed on a crystalline substrate having surface anisotropy. In FIG. 4, the polymer film is not present, and the film of a mesostructured silica 12, in which the tubular surfactant assemblies 31 are oriented in one direction, is directly formed on a crystalline substrate 41 having surface anisotropy.

According to the present invention, the above-mentioned mesostructured silica, film may be patterned to a desired shape, if required. For patterning, a general patterning technique can be used, such as ordinary photolithography and micromachining with a focused ion beam. These patterning processes are preferably performed before the removing process of the surfactant.

The surfactant is removed from the mesostructured silica film containing the tubular assemblies of the surfactant oriented in one direction on the substrate, whereby a mesoporous silica film having uniaxially oriented tubular mesopores is obtained. There are various methods for removing the surfactant. Any method can be used as long as it can remove the surfactant without damaging the mesoporous structure.

Calcination in an atmosphere containing oxygen is most generally used. For example, the film thus formed is calcined in air at 550° C. for 10 hours, whereby an organic component can be removed completely while the mesopore structure is maintained. In this case, the polymer film formed on the surface of the substrate is also removed. Therefore, finally, a mesoporous silica film having a uniaxially oriented mesoporous structure is directly formed on a substrate.

In addition to the above-mentioned calcination method, the surfactant may be removed by solvent extraction or with a supercritical fluid. Although it is difficult to remove organic components completely by these methods, a silica film having uniaxially oriented tube-shaped mesopores can be formed on a substrate made of a material that cannot withstand a high temperature during calcination.

Furthermore, other than by calcination or extraction, the surfactant can be removed by ozone oxidation. According to this method, the surfactant can be removed at a low temperature compared with calcination.

In the procedure as described above, a mesoporous silica film having uniaxially oriented tubular mesopores can be formed on a substrate. Depending upon the substrate to be used and the method for removing the surfactant, a polymer film may or may not be formed on the surface of the substrate. Both are applicable to the present invention.

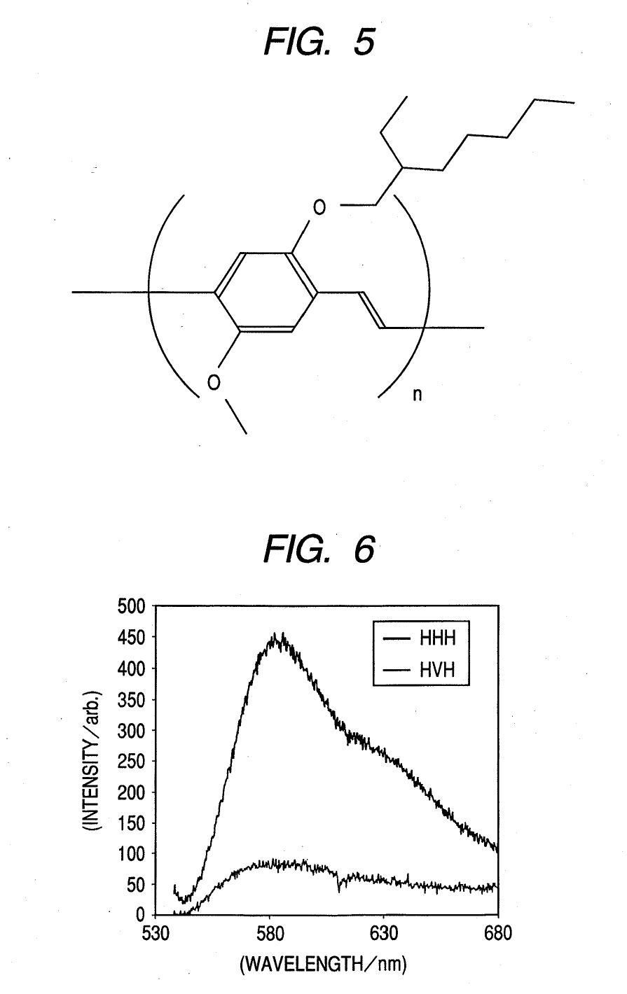

Next, a conjugated polymer is introduced into the mesopores of the silica film having uniaxially oriented tubular mesopores. A conjugated semiconductive polymer that emits strong fluorescence is particularly preferably used, but not specifically limited. For example, poly[2-methoxy-5-(2′-ethyl-hexyloxy)-1,4-phenylene vinylene] (MEH-PPV) can be used or any other soluble semiconducting polymer can be used. FIG. 5 shows the structure of MEH-PPV. A conjugated polymer is dissolved in a solvent, and a mesoporous silica film is soaked in the solution, whereby a conjugated polymer can be introduced into the mesopores. If required, the solution of a conjugated polymer to be introduced may be heated for satisfactory introduction of the polymer.

When the surface of the mesopores is modified with an organic substance beforehand to provide the hydrophobic surface, introduction of the polymer into the mesopores tends to be remarkably enhanced. For example, treatment with phenyldimethylchlorosilane can make the mesopores hydrophobic efficiently by bonding organic groups to silanol groups in the mesopores. However, the agent usable for hydrophobic treatment of the mesopores is not limited to the above, and agents other than silane coupling agents can be used as long as the same effect can be obtained. Specifically, modification of the mesopore surface is carried out by soaking the mesoporous silica film in a solution of a desired silane coupling agent. However, the modification method is not limited thereto. For example, a reaction in the gas phase is also applicable. For the improvement of the coupling reaction, a material that works as a catalyst of the reaction may be added. As a catalyst, a non-protic amine, such as triethylamine or the like, can be used.

When a mesoporous silica film on a substrate is soaked in and then taken out from a solution of a conjugated polymer, some conjugated polymer can adhere to the outer surface of the film in addition to the inner surface of the mesopores. Therefore, the removed film is washed with a solvent capable of dissolving the conjugated polymer to remove the compound attached to the outer surface of the film.

The incorporation of a conjugated polymer is not restricted to the method described above, that is, soaking the porous film into the polymer solution. By simply heating a conjugated polymer placed on the mesoporous silica film, preferably after the modification with a silane coupling agent, the polymer chains are incorporated into the mesopores. Again, heating a concentrated polymer solution on the mesoporous silica film, preferably after the modification with a silane coupling agent, leads to the successful incorporation of the polymer chains even after drying up the solvent.

As described above, a composite comprising a mesoporous silica film having uniaxially oriented tubular mesopores and a conjugated polymer introduced into the mesopores can be prepared.

Next, the characterization of the composite will be described. Characterization must be carried out both on the structure and on the optical properties.

First, the characterization of the structure will be described.

The structure of a mesoporous silica film formed on a substrate can be evaluated in detail by X-ray diffraction analysis. For analysis of a periodic structure, measurement in the 0-20 scanning geometry is used. When the produced film is measured by this method, diffraction peaks of (h00) lattice planes corresponding to a honeycomb mesopore structure are observed, whereby the formation of the regular mesostructure can be confirmed.

In order to confirm the orientation of the mesopores over the entire substrate surface, X-ray diffraction analysis is useful. However, in the above-mentioned θ-2θ scanning geometry, the information on the orientation of the mesopores cannot be obtained. For this purpose, the in-plane X-ray diffraction analysis described below is effective.

According to the in-plane X-ray diffraction analysis, X-rays are impinged on the film on the substrate at a very small angle in the vicinity of the critical angle for total reflection, and the X-ray diffracted to the in-plane direction is detected. This analysis gives the structural information on lattice planes perpendicular to the substrate surface. By measuring an in-plane rocking curve of a certain lattice plane using the in-plane X-ray diffraction analysis, the information on the orientation direction of the mesopores in the mesoporous silica film can be obtained. This technique is described in, for example, Chemistry of Materials, Vol. 12, pp. 49 (2000).

Regarding the mesoporous silica film having a uniaxially oriented mesopore structure used in the present invention, diffraction peaks assigned to (100) and (200) are observed in the θ-2θ scanning geometry, and two diffraction peaks are observed with a 180° interval in the in-plane rocking curve. From these measurements, the uniaxial orientation of the regular tubular mesopores in the film was confirmed.

Introduction of a conjugated polymer into the mesopores is often confirmed by the change in color. For example, the film to which the above-mentioned MEH-PPV has been introduced becomes uniformly red, confirming the introduction of the polymer into the mesopores. Needless to say, corresponding visible absorption spectrum can be used for the confirmation of the introduction of a conjugated polymer. As a comparison experiment, when a glass substrate without a mesoporous silica film formed thereon is soaked in the polymer solution, essentially all of the polymer adhering to the surface is removed in the subsequent washing process, and color change cannot be observed. In addition to these methods, introduction of the polymer can be confirmed by IR. However, in this case, contrivance may be needed for the measurement, such as the use of the attenuated total reflectance (ATR) method and the use of a substrate that is transparent in the infrared region.

Next, characterization of the optical properties will be described. For the fluorescence from the film, the polarization dependency of both excitation light and fluorescence must be determined. In this case, the film is irradiated with excitation light with the electric field parallel or perpendicular to the orientation of the mesopores in the mesoporous silica film determined by the X-ray diffraction analysis, and the fluorescence emitted from the film is measured through a second polarizer. The intensities of the fluorescence are measured for the component with the electric field parallel and perpendicular to the orientation of the mesopores.

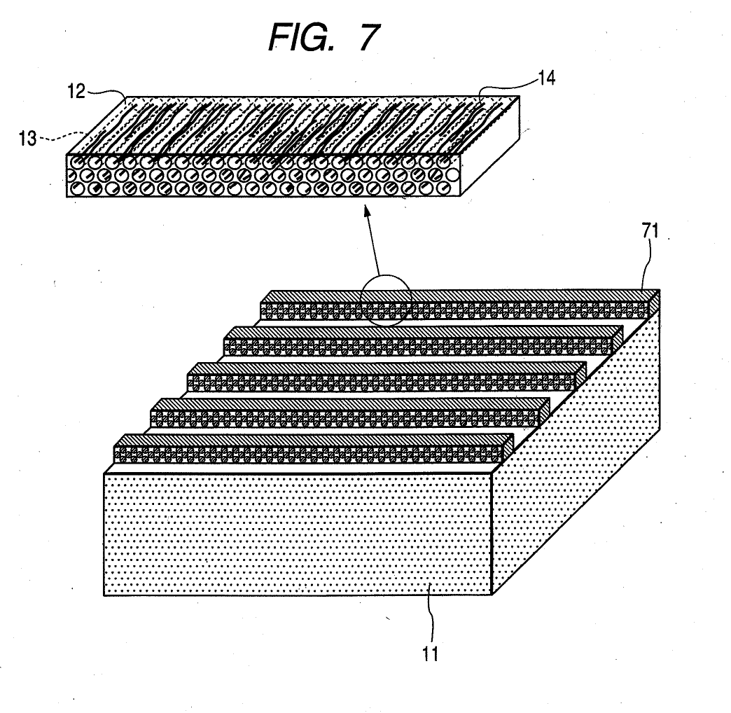

For the polarized light-emitting film of the present invention, four measurements are carried out: (excitation lights with the electric field component parallel and perpendicular to the orientation of the mesopores)×(fluorescence with the electric field component parallel and perpendicular to the orientation of the mesopores). As a result, the strong fluorescence is observed only in the optical geometry where the electric field of the excitation light and the electric field of the fluorescence are both parallel to the orientation of the mesopores, as shown in FIG. 6. This is attributed to the high-degree uniaxial orientation of the polymer chains in the mesopores.

As described above, according to the present invention, by highly controlling the orientation of meso-scaled spaces of a porous material in macroscopic scales by a simple method based on self-organization, conjugated polymer chains can be aligned in the spaces, and whereby, the polarization of the light emitted from the polymer can be controlled.

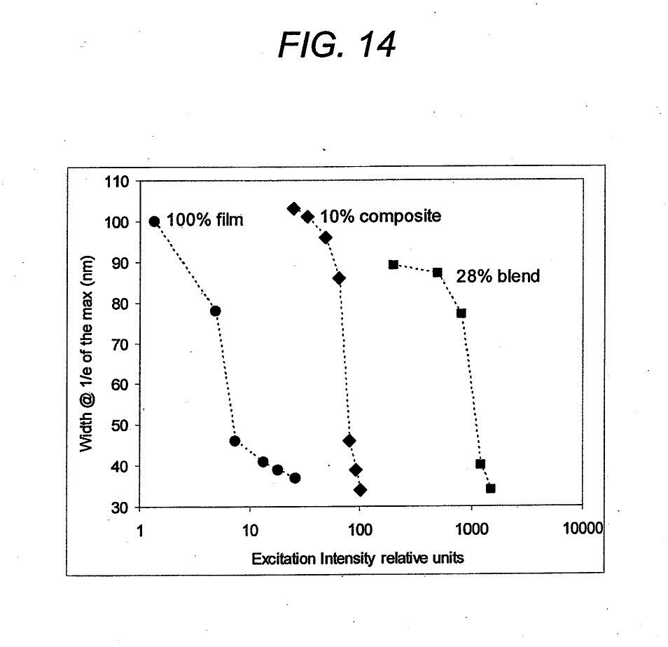

The composite material film comprising a conjugated polymer and a mesoporous silica film with a uniaxially aligned porous structure, described above, can be used as a lasing medium. When the excitation power exceeds a certain threshold intensity, the film exhibits gain narrowing and amplified spontaneous emission, which shows that the excited medium, i.e. the composite film, exhibits an optical gain. The gain narrowing and amplified spontaneous emission takes place only when stimulated emission is not overwhelmed by any losses such as a corresponding photoinduced absorption. Such photoinduced absorption is reduced when the polymer chains are isolated from each other by, for example, dilution. In the composite film of the present invention, the polymer chains are mostly isolated inside the tubular mesopores, which is favorable for obtaining optical gain. In addition to the isolation effect, the composite film of the present invention has another advantage for obtaining a gain due to the effect of alignment of the conjugated polymer chains. Because all the chromophores, i.e. conjugated polymer molecules, are uniaxially aligned in the tubular pores, a majority of the emitted photons can contribute to the stimulated emission. This effect dramatically lowers the threshold excitation intensity for lasing, as shown in FIG. 14. Because of the highly aligned chromophores in the film, the amplified spontaneous emission is highly polarized along the direction of the mesopores, that is, along the alignment direction of the polymer chains.

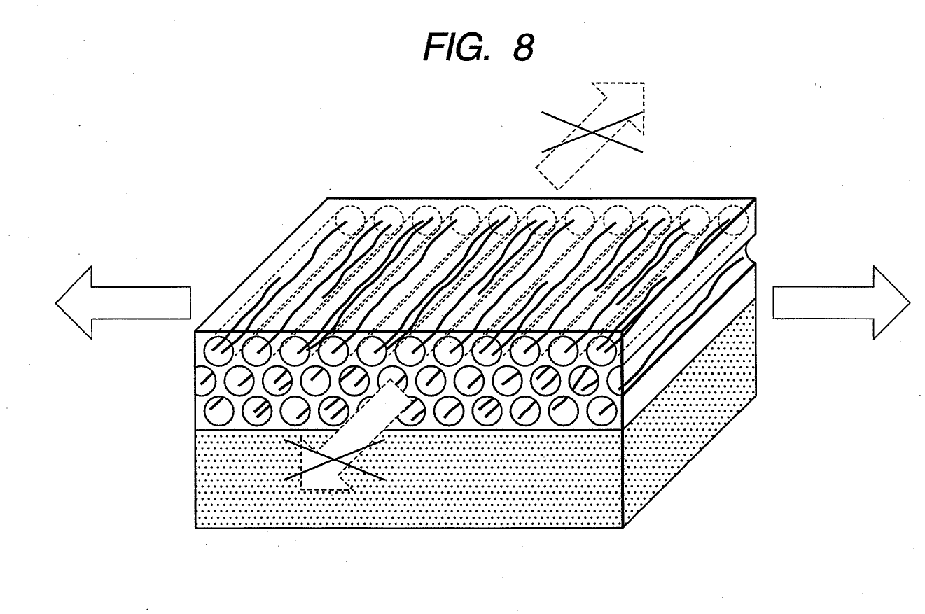

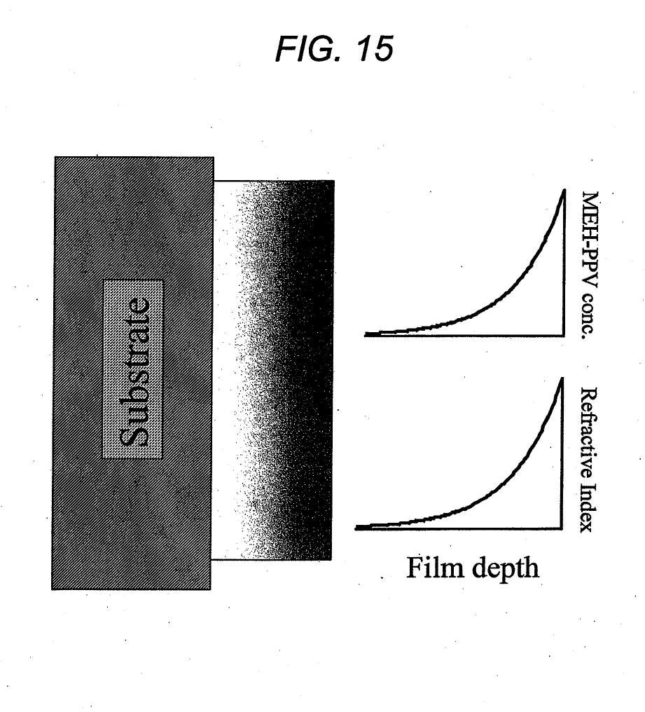

In this material, because the refractive index of the conjugated polymer is higher than that of the mesopores framework, the refractive index of the composite film depends on the concentration of conjugated polymer. The polymer concentration decreases with distance from the top surface due to the kinetics of incorporation, resulting in a monotonically decreasing refractive index along the perpendicular direction to the tubular mesopores of the composite film, as shown in FIG. 15. This refractive index gradient defines an asymmetric waveguide. When the composite film is excited in vacuum or in air strong amplified spontaneous emission is observed when the thickness of the film exceeds the cutoff thickness for formation of the waveguide. The cutoff thickness can be lowered when the top surface of the composite film is placed in contact with a medium with a high refractive index. If the new medium has a refractive index closer to that of the mesopores structure, a more symmetric waveguide will result; symmetric waveguides have much lower cut-off thicknesses than asymmetric waveguides. Preferably, the high refractive index medium is chemically inert to the lasing layer and optically transparent, like, for example, glycerol. In either of the symmetric and asymmetric waveguides, light is emitted only from the edges of the film. In the lasing layer of the present invention, all the chromophores are aligned along the tubular pores, therefore substantially all the photons are emitted with a propagation direction perpendicular to the mesopores. This is to say, no emission is observable in the direction along the pores. When the rectangular-shaped composite film is formed on a substrate with two paired sides being parallel and perpendicular to the pore direction, respectively, lasing takes place from only one pair of sides, parallel to the pore direction, as schematically shown in FIG. 8.

Hereinafter, the present invention will be described in more detail by way of Examples. However, the present invention is not limited to Examples.

### EXAMPLES

### Example 1

In this example, a mesostructured silica film having a uniaxially oriented tubular micelle assembly was produced on a substrate provided with a polyimide alignment film subjected to rubbing treatment thereon. The resultant silica film on the substrate was calcined in air to form a mesoporous silica film. Thereafter, poly[2-methoxy-5-(2′-ethyl-hexyloxy)-1,4-phenylene vinylene] (MEH-PPV) was introduced into the mesopores, thereby producing a composite film that can emit highly polarized fluorescence. The structure of the film produced in this Example 1 is schematically shown in FIG. 1.

After a silica glass substrate was washed with acetone, isopropyl alcohol, and pure water, its surface was cleaned in an ozone generation apparatus. Then the substrate was coated with a solution of polyamic acid A in NMP by spin coating. The polyamic acid on the silica glass substrate was baked at 200° C. for one hour to convert to polyimide A having the following structure.

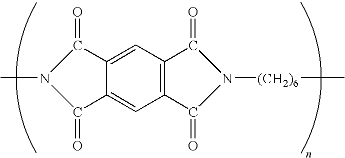

The film of polyimide A thus obtained was subject to rubbing treatment under the conditions shown in Table 1, and the obtained polyimide A film on the silica glass substrate was used as the substrate for the mesostructured silica film formation.

TABLE 1
Rubbing conditions of Polyimide A

| Cloth material | Nylon |
|---|---|
| Roller diameter (mm) | 24 |
| Pressing depth of | 0.4 |
| substrate (mm) | |
| Rotation number (rpm) | 1000 |
| Stage speed (mm/min) | 600 |
| Repetition number | 2 |

A mesostructured silica film was formed on the substrate with the rubbing-treated polyimide film. In this Example 1, a nonionic surfactant polyethylene oxide 10 cetyl ether (C₁₆H₃₃ (OCH₂CH₂)₁₀OH, C₁₆EO₁₀) having polyethylene oxide as a hydrophilic group was used.

5.52 g of C₁₆EO₁₀ was dissolved in 129 ml of pure water, and 20.6 ml of concentrated hydrochloric acid (36%) was added to the mixture, and stirred thoroughly. Then 2.20 ml of tetraethoxysilane (TEOS) was added to the solution, and stirred for 3 minutes. The molar ratio of the each component in the final solution was TEOS:H₂O:HCl:C₁₆EO₁₀=0.1:100:3:0.11.

The above-mentioned substrate with the rubbed polyimide A film was held in the reactant solution with the polymer-coated surface downward, in a Teflon vessel 21 having a structure shown in FIG. 2. The vessel was sealed at 80° C. for 3 days for the formation of a mesostructured silica film. To achieve the satisfactory uniaxial alignment of the mesopores in the mesostructured silica film, the substrate was covered with another silica glass plate using a spacer during the reaction.

The substrate placed in the reactant solution for a predetermined period of time was taken out from the vessel, and thoroughly washed with pure water and was dried at room temperature in an ambient atmosphere. It was confirmed that a continuous mesostructured silica film was formed on the substrate. The thickness of the mesostructured silica film was determined to be 200 nm by a profilometer.

This film was analyzed by X-ray diffraction analysis. As a result, a strong diffraction peak corresponding to a plane interval of 5.02 nm, assigned to the (100) plane of a mesostructured silica of hexagonal porous structure, was confirmed. Thus, the film was confirmed to have a mesoporous structure in which tubular mesopores are hexagonally packed.

In order to quantitatively evaluate the uniaxial orientation of a mesopores in the mesostructured silica film, the film was analyzed by in-plane X-ray diffraction. The in-plane rotation angle dependency on the (110) plane diffraction intensity(in-plane rocking curve) measured in this Example 1 showed that, the mesopores in this mesostructured silica film was uniaxially oriented in a direction perpendicular to the rubbing direction of the polyimide film. The full width at half maximum of the distribution of the orientation-direction of the mesopores was estimated to be about 19° from the diffraction peak in the in-plane rocking curve

Next, the mesostructured silica film formed on the substrate was calcined to remove the surfactant from the mesopores, whereby a mesoporous silica film was obtained. Calcination was carried out by increasing the temperature up to 550° C. by 2° C./minute and the subsequent keeping at 550° C. for 10 hours. After cooling down to room temperature, the mesostructured silica film was observed with optical microscopy. Neither peeling off of the film from the substrate nor cracking in the film was observed after the calcination. This is attributed to the fact that the polyimide film is thin enough to be removed without separating the mesoporous silica film and the substrate.

The film after the calcination was analyzed by X-ray diffraction. A strong diffraction peak corresponding to the lattice plane with a distance of 4.37 nm, assigned to the (100) plane of a mesostructured silica with a hexagonal porous structure was observed. This result confirms that the mesopore structure was held.

Furthermore, the film after the calcination was analyzed by in-plane X-ray diffraction analysis. As a result, the same diffraction profile as that before the calcination was obtained, and it was confirmed that the orientation distribution of the mesopores were completely held even after the calcination.

Then, the calcined mesoporous silica film was treated with a silane coupling agent to make the inner walls of the mesopores hydrophobic. In this Example 1, the film immediately after the calcination was soaked in phenyldimethylchlorosilane overnight, whereby silanol groups on the inner surface of the mesopores silica were modified. In this case, triethylamine was added as a catalyst for the coupling reaction. The mesoporous silica film after the reaction was washed with hexanes and dried at 110° C. The films were then washed a final time with methanol and dried again at 110° C.

Next, this film was soaked in an 1% chlorobenzene solution of MEH-PPV to introduce MEH-PPV into the mesopores. MEH-PPV used herein had a weight-average molecular weight of 100,000 or less. While the substrate was being soaked, the solution was heated to 80° C. After 48 hours, the substrate was taken out, and washed with chlorobenzene to remove excess MEH-PPV adhering to the outer surface.

Thus produced mesoporous silica film with MEH-PPV introduced thereto was dried in air, and optical measurements were conducted on the dried film that appeared uniformly orange/red.

Thus, obtained was a mesostructured silica film formed on a substrate, containing MEH-PPV in the uniaxially oriented tubular mesopores thereof. The in-plane X-ray diffraction analysis confirmed that the mesoporous silica film after the MEH-PPV introduction have an intact uniaxially oriented hexagonal mesoporous structure.

Next, a method for measuring the fluorescent behavior of the film thus produced will be described.

As an excitation light source, the 532 nm line of a frequency doubled diode pumped solid state Nd:YAG laser was used. The light was then circularly polarized using a ¼ wave plate and a Glan-Thomson calcite polarizer was employed in order to obtain a high-degree of polarization. The sample was fixed so that the mesopores are arranged horizontally, and the direction of the electric field of the excitation light was changed so as to be parallel or perpendicular to the direction of the mesopores of the mesostructure film. The polarization direction was rotated using a half wave plate. The intensity of the fluorescence emitted from the sample was measured through a polarizer to obtain the information on the polarization condition in the fluorescence. The polarizer was set so that the polarization direction becomes parallel and perpendicular to the direction of the mesopores in the sample film. In the apparatus used in the present example, a spectrometer consisting of a linear CCD detector and a grating monochromator with no polarization dependence was used to measure the emission.

In the present example, in order to describe the anisotropy of the measured light emission intensity, a symbol “I” representing the intensity will be provided with abbreviations of H (Horizontal) and V (Vertical) representing the three directions: the polarization direction of the excitation light, the polarization direction of the fluorescence, and the orientation direction of the mesopores, in this order. For example, the intensity represented by I_{HVH} refers to the following case: when the mesopores are horizontally arranged, the excitation light with the electric field parallel to the orientation direction of the mesopores is made incident, and the polarized light emission with the electric field perpendicular to the orientation direction of the mesopores is observed.

In the present example, a linear CCD detector was used.

Excitation light with the electric field polarized parallel to the direction of the mesopores was made incident upon a sample film fixed so that the mesopores were arranged horizontally, and the fluorescence was observed in the two polarization directions, i.e., the geometry of HHH and the geometry of HVH. FIG. 6 shows the fluorescence spectra measured in these two geometries. In the film produced in the present example, the intensity ratio between I_{HHH} and I_{HVH} was determined to be 11.2, and the film of the present invention was confirmed to exhibit highly polarized light emission.

Furthermore, in the case where the polarization direction of the incident light is perpendicular to the orientation direction of the mesopores, i.e., in VHH and VVH geometries, fluorescence was hardly observed in both geometries.

### Example 2

In this Example 2, a mesostructured silica film in which honeycomb packed tubular micelles were uniaxially aligned was formed on a substrate in the same manner as in Example 1, except that polyamide A was replaced with polyimide B, and the prepared silica film was subjected to patterning. Thereafter, the surfactant was removed, and MEH-PPV was introduced into the mesopores, whereby a patterned composite film exhibiting highly polarized light emission was produced.

The structure of the film produced in the present example is as schematically shown in FIG. 7.

A silica glass substrate was washed with acetone, isopropyl alcohol, and pure water and its surface was cleaned in an ozone generation apparatus. Then the substrate was coated with a solution of polyamic acid B in NMP by spin coating. The polyamic acid on the silica glass substrate was baked at 200° C. for one hour to convert to polyimide B having the following structure.

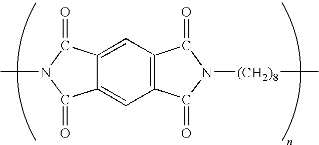

The polyimide B has substantially the same structure as that of the polyimide A, except that the length of the methylene group of the spacer is different.

The polyimide film was subject to rubbing treatment under the same conditions as in Example 1. Then, a mesostructured silica film was produced in the same manner as in Example 1. The film thus formed was a continuous transparent film and the appearance was the same as the one prepared in Example 1. The thickness was determined to be 200 nm v by a profilometer.

The mesostructured silica film produced in this Example 2 was analyzed by X-ray diffraction analysis. As the results, it was clarified that the honeycomb-packed tubular micelles are uniaxially aligned in a direction perpendicular to the rubbing direction. The full width at half maximum of the distribution of orientation directions was measured to be about 18° from the diffraction peak in the in-plane rocking curve.

Next, the film was patterned in a line shape by using a gallium focused ion beam. Patterning with the focused ion beam was performed by optimizing the conditions such as the accelerating voltage and the scanning speed to obtain a 2 μm-width/1 μm-space-parallel lines pattern without the residues of the mesostructured silica between the lines. As schematically shown in FIG. 7, the longitudinal direction of the line-shaped pattern 71 was made perpendicular to the orientation direction of the mesopores. The sample film after the patterning was calcined under the same conditions as in Example 1 to remove the surfactant from the mesopores, whereby a patterned mesoporous silica film was obtained.

The calcined film was soaked in phenyldimethylchlorosilane under the same conditions as in Example 1 to make the inner surface of the mesopores silica hydrophobic. Thereafter, MEH-PPV having a weight-average molecular weight of 100,000 or less was introduced into the mesopores under the same conditions as in Example 1. The film after introduction of MEH-PPV was examined by X-ray diffraction analysis. As a result, it was confirmed that even if patterning was performed, the mesoporous structure did not change by calcination and the following introduction of MEH-PPV.

Fluorescent behavior of this film was observed in the same manner as in Example 1, using the same optical system. As a result, the intensity ratio of I_{HHH} and I_{HVH} was similar to that observed with non-patterned film, showing highly anisotropic fluorescence. As in Example 1, when the polarization direction of the incident light was perpendicular to the orientation direction of the mesopores, i.e., in VHH and VVH arrangements, fluorescence was hardly observed.

From these results, it was shown that the polymer chains 14 are aligned in the uniaxially oriented mesopores 13 as schematically shown in the enlarged figure in FIG. 7.

When the fluorescent film in such a line-shaped pattern was prepared on a substrate surface with optimized refractive index and reflectivity, the direction of light emission from the film would be controlled.

This fluorescent film could be used as a polarized light source for a liquid crystal display: When the intensity ratio of the polarized light of the two directions, i.e. the ratio of I_{HHH} and I_{HVH}, is 3 or more, satisfactory black is displayed.

### Example 3

In this example, a mesostructured silica film in which honeycomb-packed tubular micelles are uniaxally aligned was formed on a silica glass substrate in the same manner as in Example 1 using the same polyimide A. Thereafter, the surfactant was removed by calcination followed by the silylation process according to the same procedures as in Example 1. The thickness of this film was measured by thin film interference and by profilometry to be about 450 nm thick.

As in Example 1, MEH-PPV, with a small amount of chlorobenzene to enhance mobility, was placed on the silylated mesoporous silica film. The MEH-PPV on the film was heated at 80° C. in an air atmosphere for 2 days. After heating, the solvent was removed. The excess MEH-PPV adhering to the outer surface of the mesoporous silica film was removed by washing with chloroform. The film after MEH-PPV incorporation and washing was uniformly colored orange/red. The XRD pattern of the mesoporous silica film after the incorporation of MEH-PPV shows the retention of the regular porous structure.

The polarized fluorescent property of the film was investigated in the same manner as in Example 1. Strong fluorescence polarized parallel to the direction of the mesopores was observed as in Example 1. The observed dichroic ratio was almost the same value as that in Example 1, showing the highly aligned polymer chains in the aligned mesopores.

### Example 4

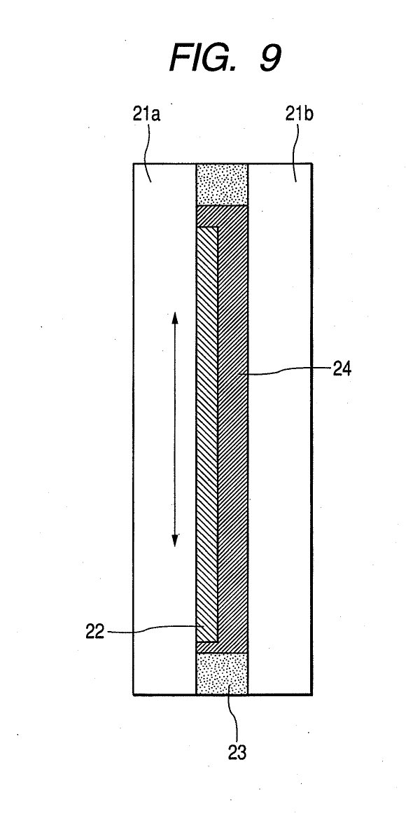

In this example, the composite film of Example 3 was used as a lasing layer. The structure of the lasing device is schematically shown in FIG. 9. The composite film 22 formed on a glass plate 21a, which showed strong polarized fluorescence, was placed facing another glass plate 21b with a certain gap. The distance of the gap was controlled using a spacer 23 with a given thickness. Into this gap, glycerol 24 was injected to form a more symmetric waveguide structure. In FIG. 9, the direction of the mesopores in the composite film 22 is shown by the arrow.

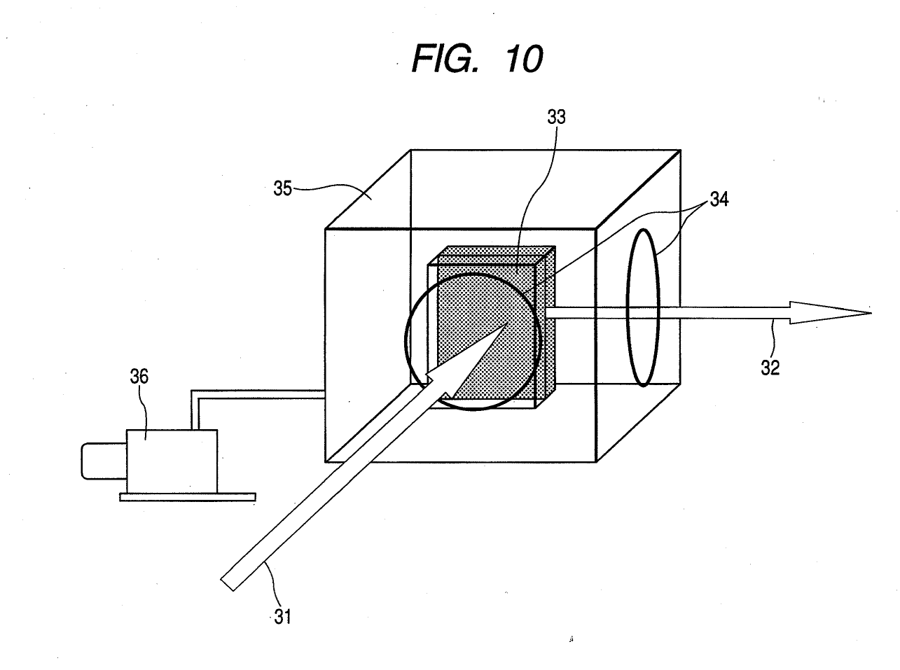

The fluorescent composite film of the present invention in the said symmetric waveguide structure was placed in an optical cryostat. The schematic illustration of the geometry for the measurement of lasing behavior is shown in FIG. 10. The chamber 35 was evacuated using a rotary pump 36. A high energy pulsed laser whose wavelength was resonant with the MEH-PPV absorption was focused on the composite film through a window 34 on the vacuum chamber. The excitation light was incident on the film from the glycerol side. The emission 32 from the composite film was measured at a 90° geometry to the incident laser, as shown in FIG. 10, through another window on the chamber. The emission was measured as a function of the incident laser power.

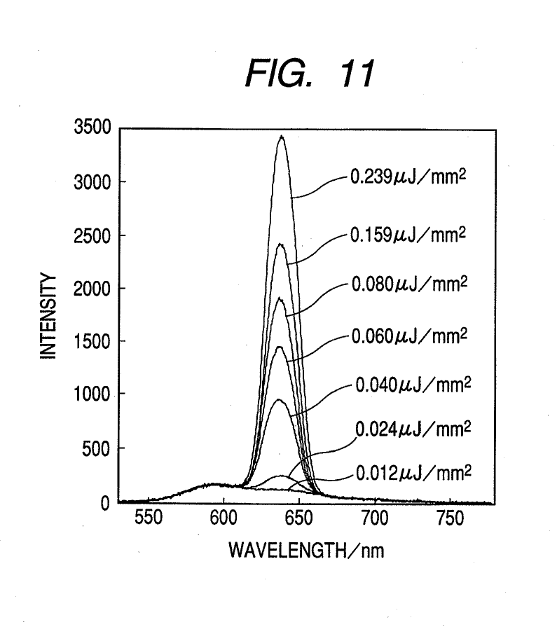

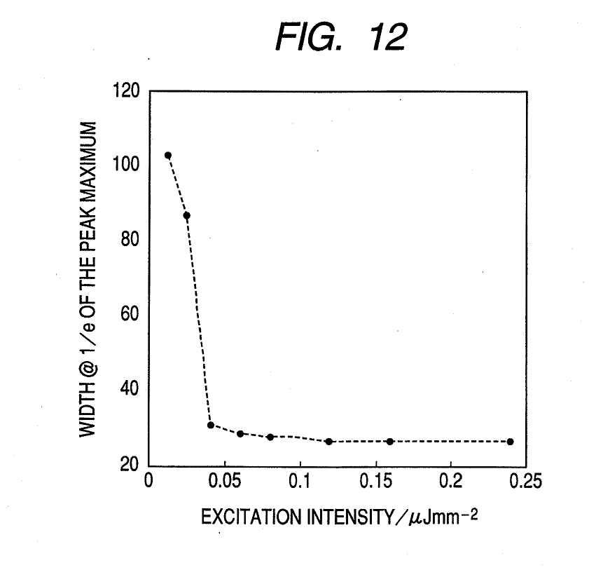

The excitation power dependence of the emission spectra is shown in FIG. 11. The gain narrowing is clearly observed. In this Figure, the emission intensity is normalized to the intensity of the spontaneous portion of the emission. To show the change of the emission width clearly, the full width of the emission is plotted against the excitation power, as shown in FIG. 12. The existence of a clear threshold is shown at relatively low excitation power.

This threshold intensity for lasing in the composite film is considerably lower than in blends of MEH-PPV and polystyrene that have the same optical density and polymer concentration as the composite, as shown in FIG. 14. Amplified spontaneous emission takes place in the composite films at very low excitation intensities due both to the suppression of losses from interchain interactions and to the enhanced stimulated emission efficiency that results from the polymer chains being mostly parallel to each other.

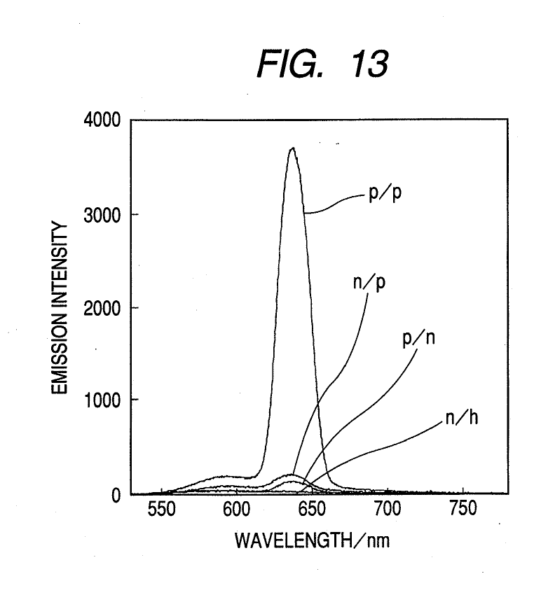

Polarization of the lasing light was measured in the same manner as the measurement of the polarized fluorescence. The result is shown in FIG. 13. The abbreviations p and n show the polarization of excitation and emission in this order (parallel:p or normal:n). For example, n/p shows that the composite film was excited with polarization normal to the pore direction, and the parallel polarization component of the emission was measured. The maximum emission intensity was observed under the geometry that the polarizations of excitation and emission light were both parallel to the alignment direction of the mesopores. The minimum emission intensity, which was very nearly zero, occurred when the polarizations of excitation and emission light were both perpendicular to the pore direction. The ratio of the maximum and minimum intensities was estimated to be ˜140 by simple calculation of the emission intensities. Taking into account that the intensity measured under both perpendicular geometries is caused by scattering, the intrinsic anisotropy must be even larger. The observed highly polarized lasing is caused by the highly aligned polymer chains in the aligned mesopores.

When the sample was rotated by 90°, that is, the pore direction was vertical, the observed emission was drastically decreased. This shows that the direction of emission was strictly controlled by the porous structure. In other words, because all the chromophores, i.e. the conjugated polymer chains, were aligned along the pore direction, the emission was observed only in the direction perpendicular to the pore direction.

As described above, according to the present invention, a mesoporous silica film having uniaxially oriented regular mesopores formed on a substrate is used as a host material, and a conjugated polymer is introduced into the mesopores, whereby a film material emitting highly polarized fluorescence can be produced by a simple method.

In addition to that, according to the present invention, a lasing layer with a low threshold excitation power can be formed by forming a waveguide structure.

Various other modifications will be apparent too and can be readily made by those skilled in the art without departing from the scope and spirit of this invention. Accordingly, it is not intended that the scope of the claims appended hereto be limited to the description as set forth herein, but rather that the claims be broadly construed.

1.-8. (canceled)

9. A method for producing a polarized light-emitting film comprising the steps of:
forming on a substrate a mesostructured silica film containing a plurality of tubular molecular assemblies of a surfactant aligned in one direction;
removing the surfactant from the mesostructured silica film to form hollow tubular mesopores;
reacting the surfaces of the hollow mesopores with a silane coupling agent; and
introducing a conjugated polymer into the mesopores.

10. The method according to claim 9,
wherein the method further comprises a step of patterning the mesostructured silica film in a desired pattern, and
wherein the step of patterning is carried out between the step of forming on a substrate a mesostructured silica film containing a plurality of tubular molecular assemblies of a surfactant arranged in one direction and the step of removing the surfactant from the mesostructured silica film to form hollow tubular mesopores.

11. The method according to claim 9, wherein the substrate is capable of controlling the orientation of the tubular mesopores in the mesostructured silica film formed thereon to one direction.

12. A method for producing a polarized light-emitting film comprising the steps of:
forming on a substrate a polymer film that is capable of controlling the orientation of tubular mesopores in a mesostructured silica to one direction;
forming on the polymer film a mesostructured silica film containing a plurality of tubular molecular assemblies of a surfactant arranged in one direction;
removing the surfactant from the mesostructured silica film to form hollow tubular mesopores;
reacting the surfaces of the hollow mesopores with a silane coupling agent; and
introducing a conjugated polymer into the mesopores.

13. The method according to claim 12,
wherein the method further comprises a step of patterning the mesostructured silica film in a desired pattern, and
wherein the step of patterning is carried out between the step of forming on a substrate a mesostructured silica film containing a plurality of tubular molecular assemblies of a surfactant arranged in one direction and the step of removing the surfactant from the mesostructured silica film to form hollow tubular mesopores.

14. A method according to claim 12, wherein the surfactant is removed by calcination.

15.-24. (canceled)

25. The fabrication of a graded refractive index layer formed by the diffusive kinetics of polymers or other high-index materials incorporated into the channels of an aligned mesoporous silica film.

26.-29. (canceled)

30. The method according to claim 9 or 12 wherein the mesostructured silica film has a thickness from greater than 6 nm to about 450 nm.
